(19) United States
(12) Patent Application Publication
(10) Pub. No.: US 2023/0143547 A1
(43) Pub. Date: May 11, 2023

(54) CONNECTOR

(71) Applicant: SUMITOMO WIRING SYSTEMS, LTD., Mie (JP)

(72) Inventor: Yusuke WATANABE, Mie (JP)

(21) Appl. No.: 17/908,436

(22) PCT Filed: Mar. 2, 2021
(86) PCT No.: PCT/JP2021/007859

§ 371 Date: Aug. 31, 2022

(30) Foreign Application Priority Data
Mar. 4, 2020 (JP) 2020-037048

(51) Int. Cl. H01R 13/453; H01R 13/6581; H01R 13/52; H01R 13/516; H01R 13/629

(52) U.S. Cl. CPC H01R 13/453; H01R 13/6581; H01R 13/52; H01R 13/516; H01R 13/629

(57) ABSTRACT

The housing includes a protecting portion for protecting the terminal. The protecting portion projects in the first direction from the facing surface. A projection amount of the protecting portion is larger than that of the terminal. The protecting member includes a first through hole for insertion of the terminal and a second through hole for insertion of the protecting portion. The protecting member is displaced between a first position between a tip of the protecting portion and a tip of the terminal in the first direction and a second position between the tip of the terminal and the facing surface in the first direction.

### TECHNICAL FIELD

The present disclosure relates to a connector.

### BACKGROUND

Patent Document 1 describes a connector provided with a housing, a terminal and a protecting member. The housing holds the terminal and the protecting member. The protecting member includes a through hole for insertion of the terminal. The protecting member is configured to be displaced between a first position and a second position in the housing.

When the protecting member is located at the first position, the terminal is not passed through the through hole. Thus, when the protecting member is located at the first position, the terminal is protected by the protecting member without being exposed from the protecting member.

If the protecting member is displaced from the first position to the second position, the terminal protrudes out from the through hole. That is, when the protecting member is located at the second position, the terminal is passed through the through hole. Thus, when the protecting member is located at the second position, the terminal is exposed from the protecting member. In this way, the terminal becomes electrically connectable to a mating connector.

### PRIOR ART DOCUMENT

### Patent Document

Patent Document 1: JP H10-041019 A

### SUMMARY OF THE INVENTION

### Problems to be Solved

In the connector described in Patent Document 1, the protecting member may rub against the terminal when the protecting member is displaced between the first position and the second position. In this way, the terminal may be worn.

The present disclosure aims to provide a connector capable of suppressing the wear of a terminal.

### Means to Solve the Problem

The present disclosure is directed to a connector with a housing having a facing surface facing a mating connector when the connector is assembled with the mating connector, a terminal held in the housing, the terminal projecting in a first direction from the facing surface, and a protecting member held in the housing, the protecting member moving in the first direction and a second direction opposite to the first direction in the housing, wherein the housing includes a protecting portion for protecting the terminal, the protecting portion projects in the first direction from the facing surface, a projection amount of the protecting portion is larger than that of the terminal, the protecting member includes a first through hole for insertion of the terminal and a second through hole for insertion of the protecting portion, and the protecting member is displaced between a first position between a tip of the protecting portion and a tip of the terminal in the first direction and a second position between the tip of the terminal and the facing surface in the first direction.

### Effect of the Invention

According to the connector of the present disclosure, an effect of being capable of suppressing the wear of the terminal is achieved.

### BRIEF DESCRIPTION OF THE DRAWINGS

FIG. 1 is a perspective view showing one embodiment of an electrical connection device provided with a connector.

FIG. 2 is a plan view of a first connector viewed from a first direction.

FIG. 3 is a plan view of a second connector viewed from a second direction.

FIG. 4 is a plan view of FIG. 3 with a protecting mechanism omitted.

FIG. 5 is a section along 5-5 in FIG. 3.

FIG. 6 is a section along 6-6 in FIG. 3.

FIG. 7 is a perspective view of the protecting mechanism.

FIG. 8 is a perspective view of the protecting mechanism viewed from an angle different from that in FIG. 7.

FIG. 9 is a section in which a protecting member is displaced to a second position from a position of FIG. 5.

FIG. 10 is a section in which the protecting member is displaced to the second position from a position of FIG. 6.

FIG. 11 is a perspective view in which the protecting member is displaced to the second position from a position of FIG. 8.

### DETAILED DESCRIPTION TO EXECUTE THE INVENTION

### Description of Embodiments of Present Disclosure

First, embodiments of the present disclosure are listed and described.

[1] The connector of the present disclosure is provided with a housing having a facing surface facing a mating connector when the connector is assembled with the mating connector, a terminal held in the housing, the terminal projecting in a first direction from the facing surface, and a protecting member held in the housing, the protecting member moving in the first direction and a second direction opposite to the first direction in the housing, wherein the housing includes a protecting portion for protecting the terminal, the protecting portion projects in the first direction from the facing surface, a projection amount of the protecting portion is larger than that of the terminal, the protecting member includes a first through hole for insertion of the terminal and a second through hole for insertion of the protecting portion, and the protecting member is displaced between a first position between a tip of the protecting portion and a tip of the terminal in the first direction and a second position between the tip of the terminal and the facing surface in the first direction.

According to the above configuration, when the protecting member is located at the first position, the terminal is not passed through the first through hole. In this case, the terminal is protected by the protecting member without being exposed from the protecting member. When the protecting member is located at the second position, the terminal is passed through the first through hole. In this case, the terminal is exposed from the protecting member.

Both when the protecting member is located at the first position and when the protecting member is located at the second position, the protecting portion is passed through the second through hole. Thus, the protecting member moves while being guided by the protecting portion when the protecting member is displaced between the first position and the second position. That is, the protecting portion guides the protecting member. In this way, it is suppressed that the protecting member rubs against the terminal. As a result, the wear of the terminal is suppressed.

Here, “facing each other” in this specification indicates that surfaces or members are at positions right in front of each other and means not only a case where the surfaces or members are at positions perfectly in front of each other, but also a case where the surfaces or members are at positions partially in front of each other. Further, “facing each other” in this specification means both a case where another member different from two members is interposed between the two members and a case where nothing is present between the two members.

[2] In the above connector, the protecting portion is preferably provided to surround the terminal when the housing is viewed from the second direction.

According to the above configuration, the protecting member is less likely to be inclined when moving in the first and second directions as compared to the case where the protecting portion has, for example, a mere flat shape. In this way, the wear of the terminal can be suppressed. For example, if the protecting member moves in the first and second directions in an inclined state, the protecting member easily rubs against the terminal.

[3] Preferably, the above connector is provided with a shield member made of metal, and the shield member is provided along the protecting portion.

According to the above configuration, the shield member is provided to surround the terminal. Thus, a possibility of noise entrance from the terminal is reduced.

[4] In the above connector, the first and second through holes are preferably respectively independent holes.

According to the above configuration, an area of the holes open in the protecting member is reduced as compared to the case where the first and second through holes are constituted by one common hole. Since the terminal becomes less likely to be exposed from the protecting member in this way, a possibility that worker's fingers touch the terminal is reduced.

[5] Preferably, the above connector is provided with a pressing member provided between the facing surface and the protecting member, the pressing member presses the protecting member in the first direction, and the protecting member is pressed in the second direction by the mating connector when the connector and the mating connector are assembled.

According to the above configuration, the protecting member is displaced to the second position as the connector and the mating connector are assembled. As the connector and the mating connector are disassembled, the protecting member is displaced to the first position. Thus, a possibility that the protecting member is inadvertently displaced to the second position is reduced. That is, since the terminal becomes less likely to be exposed from the protecting member, a possibility that the worker's fingers touch the terminal is reduced.

[6] In the above connector, preferably, the housing includes a holding portion projecting in the first direction from the facing surface, a projection amount of the holding portion is larger than that of the terminal and smaller than that of the protecting portion, the holding portion includes a first hook part on a tip thereof, the protecting member includes a third through hole for insertion of the holding portion, and the first hook part contacts the protecting member when the protecting member is located at the first position.

According to the above configuration, a movement in the first direction of the protecting member located at the first position is suppressed by the contact of the first hook part with the protecting member. In this way, a possibility of detachment of the protecting member from the housing is reduced.

[7] Preferably, the above connector is provided with a holding member to be connected to the protecting member, the holding member includes a second hook part on an end part thereof, the housing includes an insertion hole for insertion of the holding member, and the second hook part contacts the housing when the protecting member is located at the first position.

According to the above configuration, a movement in the first direction of the protecting member located at the first position is suppressed by the contact of the second hook part with the housing. In this way, a possibility of detachment of the protecting member from the housing is reduced.

[8] Preferably, the above connector is provided with a connecting member to be connected to the protecting member and the holding member in a state movable in the first and second directions with respect to the protecting member and the holding member, and the holding member is connected to the protecting member via the connecting member.

According to the above configuration, a displacement amount of the holding member becomes smaller than that of the protecting member when the protecting member is displaced from the first position to the second position. By reducing the displacement amount of the holding member when the protecting member is displaced from the first position to the second position, a protrusion amount of the holding member protruding out from the housing in the second direction from the insertion hole decreases when the protecting member is located at the second position. In this way, a possibility of interference of the holding member with another member is reduced.

### Details of Embodiment of Present Disclosure

### Embodiment

One embodiment of an electrical connection device provided with a connector of the present disclosure is described below with reference to the drawings. The electrical connection device of this embodiment is used in a connection part in a wiring harness for a high-voltage power supply of a vehicle. Note that the present invention is not limited to these illustrations and is intended to be represented by claims and include all changes in the scope of claims and in the meaning and scope of equivalents.

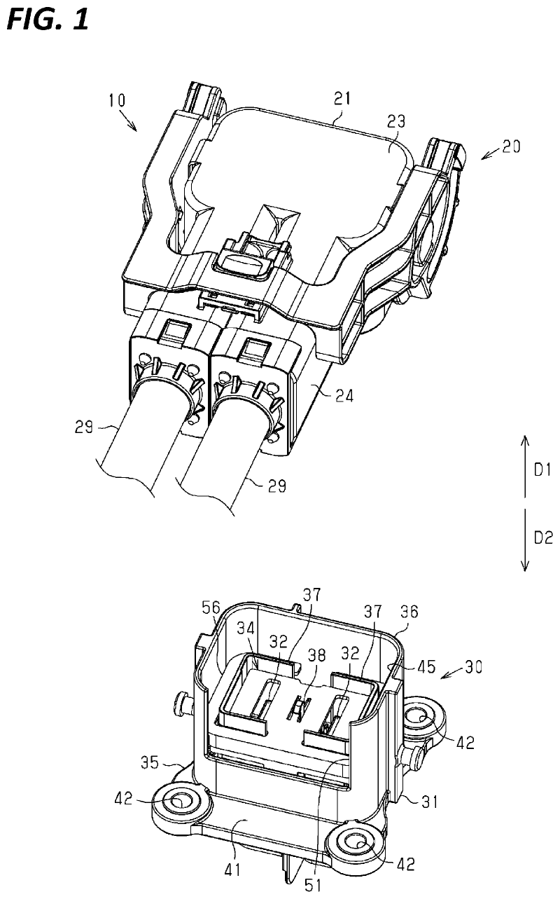

As shown in FIG. 1, an electrical connection device 10 includes a first connector 20 and a second connector 30. The first and second connectors 20, 30 are assembled with each other. The first and second connectors 20, 30 are electrically connected by being assembled with each other.

In this embodiment, a direction in which the second connector 30 relatively approaches the first connector 20 in the case of assembling the first and second connectors 20, 30 is referred to as a first direction D1. Further, a direction in which the first connector 20 relatively approaches the second connector 30 in the case of assembling the first and second connectors 20, 30 is referred to as a second direction D2. That is, the first and second directions D1, D2 are mutually opposite directions.

(First Connector 20)

First, the first connector 20 is described.

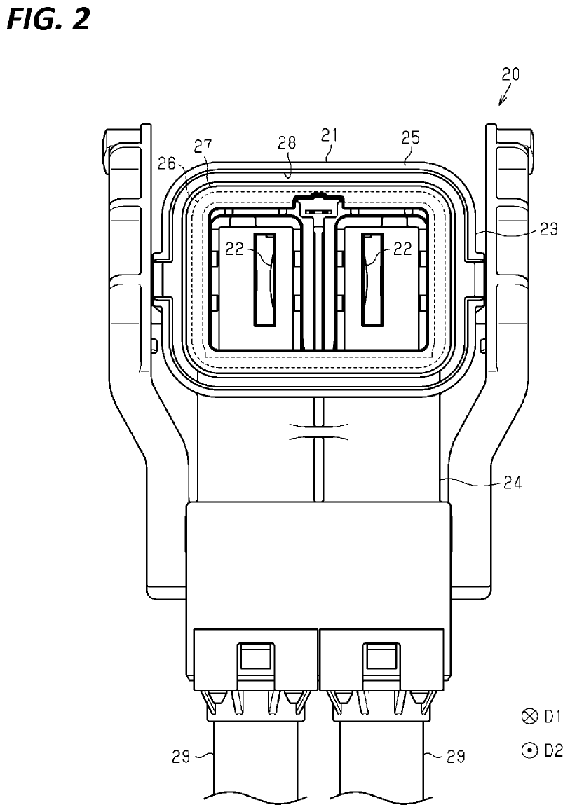

As shown in FIG. 2, the first connector 20 includes a first housing 21 and first terminals 22. The first connector 20 is a mating connector of the second connector 30.

The first housing 21 is a housing provided in the first connector 20. The first housing 21 holds the first terminals 22.

The first housing 21 includes a first accommodating portion 23 and a second accommodating portion 24. The first and second accommodating portions 23, 24 accommodate the first terminals 22. Thus, the inside of the first accommodating portion 23 and that of the second accommodating portion 24 communicate.

The first accommodating portion 23 includes an outer peripheral wall 25, an inner peripheral wall 26 and a sealing member 27.

The outer peripheral wall 25 is provided to have a rectangular shape when the first housing 21 is viewed from the first direction D1. Thus, the first accommodating portion 23 includes an accommodation opening 28 formed by the outer peripheral wall 25. The accommodation opening 28 is an opening formed in the first housing 21. The accommodation opening 28 is facing in the second direction D2 in the first housing 21. The first accommodating portion 23 of this embodiment accommodates a part of the second connector 30 through the accommodation opening 28 when the first and second connectors 20, 30 are assembled.

The inner peripheral wall 26 is provided in a region surrounded by the outer peripheral wall 25. Thus, the inner peripheral wall 26 is provided to have a rectangular shape one size smaller than the shape of the outer peripheral wall 25 when the first housing 21 is viewed from the first direction D1.

The sealing member 27 is provided on the tip of the inner peripheral wall 26. Thus, the sealing member 27 is provided to have a rectangular shape when the first housing 21 is viewed from the first direction D1. The sealing member 27 is, for example, made of a resilient material such as rubber or elastomer. The sealing member 27 contacts the second connector 30 when the first and second connectors 20, 30 are assembled. The sealing member 27 seals between the first and second connectors 20, 30 by contacting the second connector 30. In this way, sealability between the first and second connectors 20, 30 is ensured.

The second accommodating portion 24 accommodates parts of wires 29 connected to the first terminals 22. The second accommodating portion 24 is provided to extend from the outer peripheral wall 25. Specifically, the second accommodating portion 24 extends in a direction different from the first and second directions D1, D2 from one surface of the outer peripheral wall 25. Thus, a connecting direction of the first connector 20 to the second connector 30 and an extending direction of the wires 29 from the first connector 20 are different in the first connector 20. That is, the first connector 20 is an L-shaped connector bent between an input side and an output side.

The first terminal 22 is a terminal provided in the first connector 20. Two first terminals 22 are provided. The two first terminals 22 are respectively connected to two wires 29 in the first housing 21. By assembling the first and second connectors 20, 30, the first terminals 22 are electrically connected to the second connector 30.

(Second Connector 30)

Next, the second connector 30 is described.

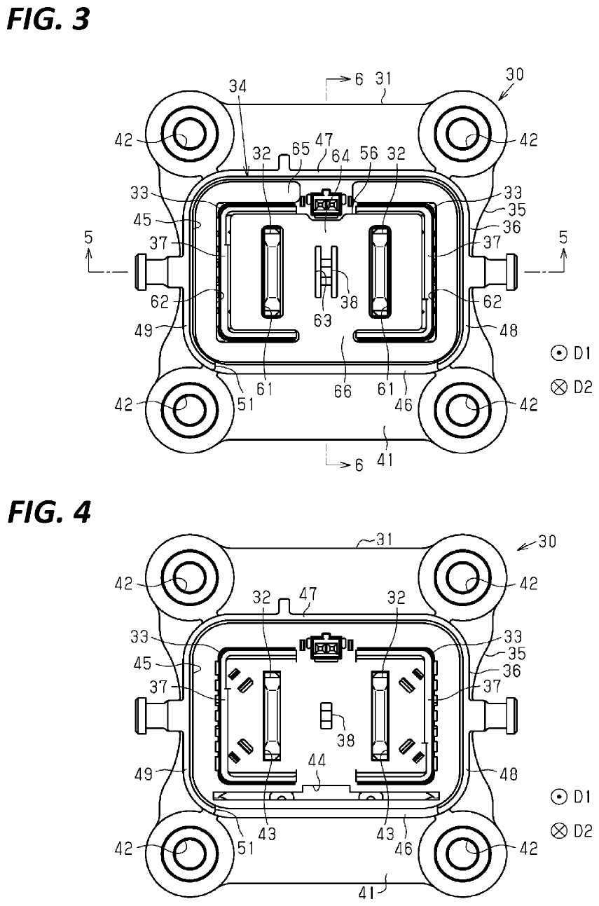

As shown in FIG. 3, the second connector 30 includes a second housing 31, second terminals 32, shield members 33 and a protecting mechanism 34. The second connector 30 is a mating connector of the first connector 20.

(Second Housing 31)

The second housing 31 is a housing provided in the second connector 30. The second housing 31 holds the second terminals 32, the shield members 33 and the protecting mechanism 34. The second housing 31 includes a fixing portion 35, a peripheral wall 36, protecting portions 37 and a holding portion 38.

As shown in FIGS. 3 and 4, the fixing portion 35 is, for example, plate-like. The fixing portion 35 of this embodiment is provided to have a rectangular shape when the second housing 31 is viewed from the second direction D2. The fixing portion 35 has a facing surface 41, fixing holes 42, first insertion holes 43 and a second insertion hole 44.

The facing surface 41 is a surface facing the first connector 20 when the second connector 30 is assembled with the first connector 20. Thus, the facing surface 41 is a surface facing the first connector 20 in the fixing portion 35. The facing surface 41 is facing the first connector 20 in the fixing portion 35. That is, the facing surface 41 is facing in the first direction D1 in the fixing portion 35. In this embodiment, the facing surface 41 includes a region facing the first connector 20 over the protecting mechanism 34.

One or more fixing holes 42 are provided. In this embodiment, four fixing holes 42 are provided. The four fixing holes 42 are located on four corners of the fixing portion 35 when the second housing 31 is viewed from the second direction D2. The fixing holes 42 are, for example, holes into which bolts, screws or the like are inserted. By inserting bolts, screws or the like into the fixing holes 42, the fixing portion 35 is fixed to another member. As a result, the second housing 31 is mounted on another member.

The first insertion hole 43 is an insertion hole for insertion of the second terminal 32. Two first insertion holes 43 are, for example, provided. The first insertion holes 43 penetrate through the fixing portion 35. The first insertion holes 43 of this embodiment are in the form of slits open in the facing surface 41.

The second insertion hole 44 is an insertion hole into which a part of the protecting mechanism 34 is inserted. The second insertion hole 44 penetrates through the fixing portion 35. The second insertion hole 44 of this embodiment is in the form of a slit open in the facing surface 41.

The peripheral wall 36 is provided to extend in the first direction D1 from the fixing portion 35. Specifically, the peripheral wall 36 projects in the first direction D1 from the facing surface 41. The peripheral wall 36 is provided to surround the first insertion holes 43 and the second insertion hole 44 in the facing surface 41 when the second housing 31 is viewed from the second direction D2. In particular, the peripheral wall 36 is provided to surround the second terminals 32 and the protecting mechanism 34 when the second housing 31 is viewed from the second direction D2. The peripheral wall 36 is inserted between the outer peripheral wall 25 and the sealing member 27 when the first and second connectors 20, 30 are assembled. At this time, the peripheral wall 36 is held in close contact with the sealing member 27.

The peripheral wall 36 of this embodiment is provided to have a rectangular shape when the second housing 31 is viewed from the second direction D2. Thus, the second housing 31 includes a connection opening 45 formed by the peripheral wall 36. The connection opening 45 is an opening formed in the second housing 31. The connection opening 45 is facing in the first direction D1 in the second housing 31. That is, in the second housing 31, a direction facing the connection opening 45 from the facing surface 41 is the first direction D1 and a direction facing the facing surface 41 from the connection opening 45 is the second direction D2. The second connector 30 is connected to the first connector 20 through the connection opening 45.

The peripheral wall 36 includes a first wall 46, a second wall 47, a third wall 48 and a fourth wall 49. The first, second, third and fourth walls 46, 47, 48 and 49 are provided to surround the second terminals 32 and the protecting mechanism 34 on four sides when the second housing 31 is viewed from the second direction D2.

The first and second walls 46, 47 are facing each other. The third and fourth walls 48, 49 are facing each other. The first wall 46 is connected to the third and fourth walls 48, 49. The second wall 47 is connected to the third and fourth walls 48, 49. The third wall 48 is connected to the first and second walls 46, 47. The fourth wall 49 is connected to the first and second walls 46, 47.

The first wall 46 is provided with an exposure opening 51. The exposure opening 51 is an opening for exposing the inside of the second housing 31. The exposure opening 51 of this embodiment is provided to have a rectangular shape when the first wall 46 is viewed from front.

The exposure opening 51 communicates with the connection opening 45. The exposure opening 51 is provided to avoid the interference of the first and second housings 21, 31 in the case of assembling the first and second connectors 20, 30. That is, the first housing 21 is fit into the exposure opening 51 in the case of assembling the first and second connectors 20, 30. The exposure opening 51 is necessary since the first connector 20 is an L-shaped connector.

The exposure opening 51 is provided at a position of the first wall 46 separated in the first direction D1 from the facing surface 41. That is, the exposure opening 51 is provided not from the tip to the base end of the first wall 46, but from the tip of the first wall 46 to a position between the tip and the base end.

As shown in FIGS. 3, 4, 5 and 6, the protecting portion 37 is, for example, plate-like. The protecting portion 37 is provided to extend in the first direction D1 from the fixing portion 35. Specifically, the protecting portion 37 projects in the first direction D1 from the facing surface 41. A projection amount of the protecting portion 37 is smaller than that of the peripheral wall 36. Thus, a distance between the tip of the protecting portion 37 and the facing surface 41 is shorter than a distance between the tip of the peripheral wall 36 and the facing surface 41.

The protecting portion 37 is provided in a region surrounded by the peripheral wall 36 in the facing surface 41. The protecting portion 37 is provided to surround the second terminal 32 when the second housing 31 is viewed from the second direction D2. The protecting portion 37 protects the second terminal 32 by surrounding the second terminal 32. In this embodiment, the protecting portion 37 is provided to partially surround the second terminal 32 when the second housing 31 is viewed from the second direction D2. For example, the protecting portion 37 is provided to surround the second terminal 32 on three sides when the second housing 31 is viewed from the second direction D2. Thus, the protecting portion 37 of this embodiment is provided to extend around the second terminal 32 while being bent when the second housing 31 is viewed from the second direction D2. The protecting portion 37 protects the second terminal 32 by surrounding the second terminal 32. Particularly, the protecting portion 37 reduces a possibility that worker's fingers touch the second terminal 32 by protecting the second terminal 32.

In this embodiment, two protecting portions 37 are provided. The two protecting portions 37 are provided to respectively surround the two first insertion holes 43. The two protecting portions 37 are provided side by side between the third and fourth walls 48, 49. In this embodiment, one of the two protecting portions 37 is provided to have a C shape and the other is provided to have an inverted C shape when the second housing 31 is viewed from the second direction D2. The two protecting portions 37 are so provided that openings thereof face each other when the second housing 31 is viewed from the second direction D2. That is, in this embodiment, the two protecting portions 37 are provided symmetrically with respect to a center of the facing surface 41 when the second housing 31 is viewed from the second direction D2.

The holding portion 38 is, for example, a projection. The holding portion 38 is provided to extend in the first direction D1 from the fixing portion 35. Specifically, the holding portion 38 projects in the first direction D1 from the facing surface 41. A projection amount of the holding portion 38 is smaller than those of the protecting portions 37. Thus, a distance between the tip of the holding portion 38 and the facing surface 41 is shorter than a distance between the tips of the protecting portions 37 and the facing surface 41. The holding portion 38 is provided between the two holding portions 37 on the facing surface 41. The holding portion 38 of this embodiment is provided at a center position of the facing surface 41 when the second housing 31 is viewed from the second direction D2.

The holding portion 38 includes a first hook part 52. The first hook part 52 is provided on the tip of the holding portion 38. The first hook part 52 is in the form of a hook. The holding portion 38 holds the protecting mechanism 34 by the first hook part 52.

(Second Terminals 32)

The second terminal 32 is, for example, a busbar. The second terminal 32 is held in the second housing 31. Two second terminals 32 are provided. The two second terminals 32 are respectively inserted into the two first insertion holes 43. Thus, the two second terminals 32 are respectively passed through the fixing portion 35. Each of the two second terminals 32 includes a first part 53 and a second part 54.

The first part 53 is a part to be connected to the first connector 20 in the second terminal 32. That is, the first part 53 contacts the first terminal 22 in the case of assembling the first and second connectors 20, 30.

The first part 53 is accommodated into the second housing 31. The first part 53 extends in the first direction D1 from the facing surface 41 by inserting the second terminal 32 into the first insertion hole 43. Thus, the second terminal 32 projects in the first direction D1 from the facing surface 41.

A projection amount of the first part 53 is smaller than that of the protecting portion 37. That is, a projection amount of the second terminal 32 is smaller than that of the protecting portion 37. Thus, a distance between the tip of the second terminal 32 and the facing surface 41 is shorter than the distance between the tip of the protecting portion 37 and the facing surface 41. In this embodiment, the projection amount of the second terminal 32 is smaller than that of the holding portion 38. In short, the distance between the tip of the second terminal 32 and the facing surface 41 is shorter than the distance between the tip of the holding portion 38 and the facing surface 41.

The two first parts 53 are provided side by side between the third and fourth walls 48, 49. In this embodiment, the two first parts 53 are provided in parallel to the third and fourth walls 48, 49. The two first parts 53 are respectively provided to be surrounded by the two protecting portions 37.

Here, “parallel” in this specification means not only strictly parallel, but also substantially parallel within a range in which functions and effects in this embodiment are achieved.

The second part 54 is, for example, a part to be connected to an unillustrated wire in the second terminal 32. Two second parts 54 are respectively connected to unillustrated two wires. The second part 54 protrudes out from the second housing 31. The second part 54 is provided on a side opposite to the peripheral wall 36 with respect to the fixing portion 35. The second part 54 is provided to extend in the second direction D2 from the fixing portion 35.

(Shield Members 33)

The shield member 33 is made of metal. The shield member 33 is, for example, a plate-like member. The shield member 33 is held in the second housing 31. The shield member 33 is provided along the protecting portion 37. Thus, the shield member 33 of this embodiment is provided along the protecting portion 37 while being bent when the second housing 31 is viewed from the second direction D2. The shield member 33 of this embodiment is provided between the protecting portion 37 and the peripheral wall 36 and mounted on the protecting portion 37.

The shield member 33 is provided to surround the second terminal 32, similarly to the protecting portion 37. A possibility that the second terminal 32 is affected by noise is reduced by the shield member 33 surrounding the second terminal 32. Further, the strength of the protecting portion 37 is improved by the shield member 33.

The shield member 33 of this embodiment is provided to partially surround the second terminal 32 when the second housing 31 is viewed from the second direction D2. The shield member 33 is provided to surround the second terminal 32 on three sides when the second housing 31 is viewed from the second direction D2.

In this embodiment, two shield members 33 are provided. The two shield members 33 are respectively provided along the two protecting portions 37. Thus, in this embodiment, one of the two shield members 33 is provided to have a C shape and the other is provided to have an inverted C shape when the second housing 31 is viewed from the second direction D2.

(Protecting Mechanism 34)

As shown in FIGS. 3, 5 and 6, the protecting mechanism 34 is a mechanism for protecting the second terminals 32. The protecting mechanism 34 includes a protecting member 56, a connecting member 57, a holding member 58 and pressing members 59. The protecting mechanism 34 is held in the second housing 31.

The protecting member 56 is a member for protecting the second terminals 32. The protecting member 56 is, for example, a plate-like member. The protecting member 56 is accommodated into the second housing 31. The protecting member 56 moves in the first and second directions D1, D2 in the second housing 31.

The protecting member 56 is provided in a region surrounded by the peripheral wall 36 in the second housing 31. The protecting member 56 includes first through hole 61, second through holes 62 and a third through hole 63. In particular, the protecting member 56 of this embodiment further includes a protecting part 64, a pressing part 65 and a coupling part 66.

The first, second and third through holes 61, 62 and 63 penetrate through the protecting member 56. In this embodiment, the first, second and third through holes 61, 62 and 63 are respectively independent holes. The first through holes 61 are holes for insertion of the second terminal 32. The second through holes 62 are holes for insertion of the protecting portions 37. In this embodiment, the second through holes 62 are also holes for insertion of the shield members 33. The third through hole 63 is a hole for insertion of the holding portion 38.

The protecting part 64 is a part surrounded by the two protecting portions 37 in the protecting member 56. Thus, the protecting part 64 is provided with the first through holes 61 and the third through hole 63.

The pressing part 65 is a part located between the peripheral wall 36 and the protecting portions 37 in the protecting member 56. Thus, the second through holes 62 are provided on a boundary between the protecting part 64 and the pressing part 65 in the protecting member 56. The pressing part 65 is a part to be pressed in the second direction D2 by the first connector 20 in the case of assembling the first and second connectors 20, 30. Specifically, the pressing part 65 is a part pressed in the second direction D2 by the sealing member 27 in the case of assembling the first and second connectors 20, 30.

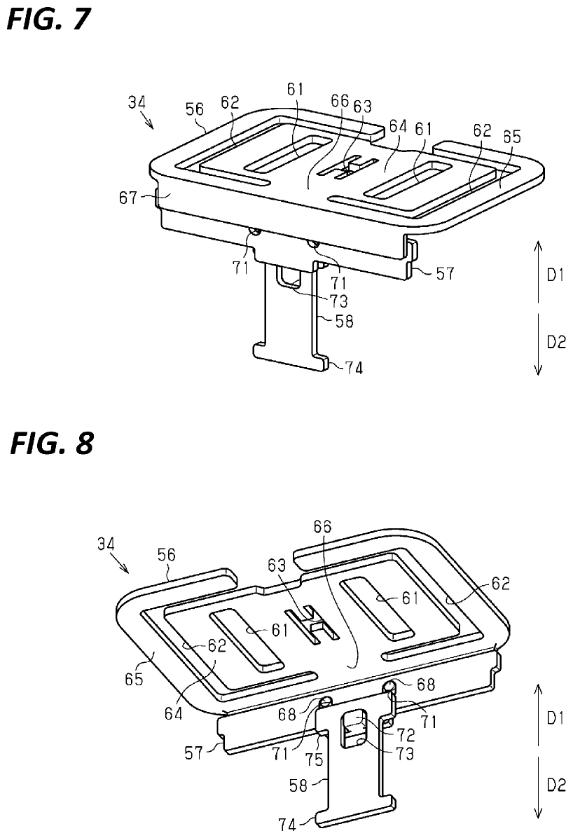

As shown in FIGS. 7 and 8, the pressing part 65 includes a mounting part 67 extending in the second direction D2. The mounting part 67 is mounted on the connecting member 57. The mounting part 67 of this embodiment includes one or more first pins 68. In this embodiment, the mounting part 67 includes two first pins 68. The protecting member 56 is mounted on the connecting member 57 via the two first pins 68.

The coupling part 66 is a part coupling the protecting part 64 and the pressing part 65. The coupling part 66 is provided between the two protecting portions 37 in the protecting member 56.

The connecting member 57 connects the protecting member 56 and the holding member 58. The connecting member 57 is mounted on the protecting member 56 and the holding member 58. The connecting member 57 is, for example, a plate-like member. The connecting member 57 includes first holes 71 and a second pin 72.

The first hole 71 is a hole for insertion of the first pin 68. Thus, two first holes 71 are provided in this embodiment. The two first holes 71 are oblong holes long in the first direction D1. Thus, the connecting member 57 is displaceable in the first and second directions D1, D2 with respect to the protecting member 56 with the first pins 68 inserted in the first holes 71.

One or more second pins 72 are provided. In this embodiment, one second pin 72 is provided. The connecting member 57 is mounted on the holding member 58 via the second pin 77.

The holding member 58 is a member for holding the protecting member 56. The holding member 58 of this embodiment is connected to the protecting member 56 via the connecting member 57. The holding member 58 is, for example, a plate-like member. The holding member 58 includes a second hole 73, a second hook part 74 and a third hook part 75.

The second hole 73 is a hole for insertion of the second pin 72. The second hole 73 is an oblong hole long in the first direction D1. Thus, the holding member 58 is displaceable in the first and second directions D1, D2 with respect to the connecting member 57 with the second pin 72 inserted in the second hole 73. That is, the holding member 58 is movable in the first and second directions D1, D2 with respect to the protecting member 56. From this, the connecting member 57 can be said to be connected to the protecting member 56 and the holding member 58 while being movable in the first and second directions D1, D2 with respect to the protecting member 56 and the holding member 58.

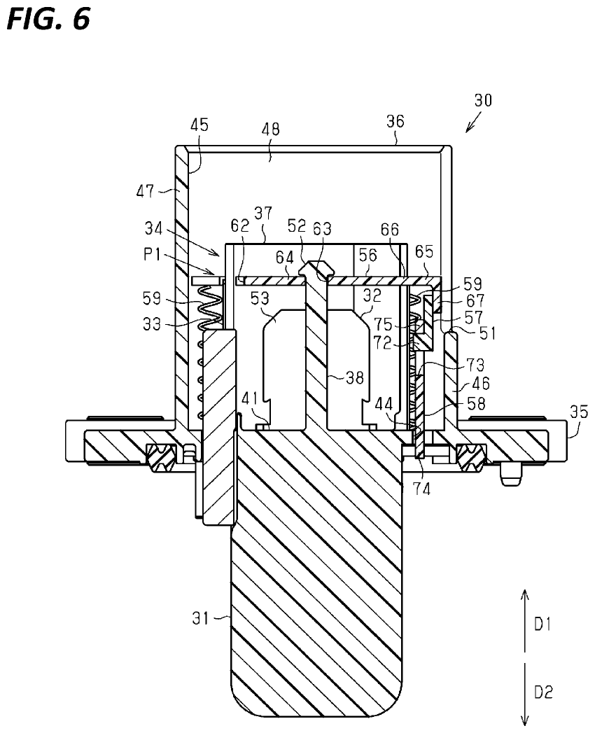

As shown in FIG. 6, the holding member 58 is inserted into the second insertion hole 44. That is, the second insertion hole 44 is an insertion hole for insertion of the holding member 58.

The second and third hook parts 74, 75 are respectively provided on end parts of the holding member 58. The second hook part 74 is provided on one end of the holding member 58, and the third hook part 75 is provided on the other end of the holding member 58. The second hook part 74 is located forward of the third hook part 75 in the second direction D2. That is, the second hook part 74 is located forward of the fixing portion 35 in the second direction D2. The third hook part 75 is located forward of the fixing portion 35 in the first direction D1.

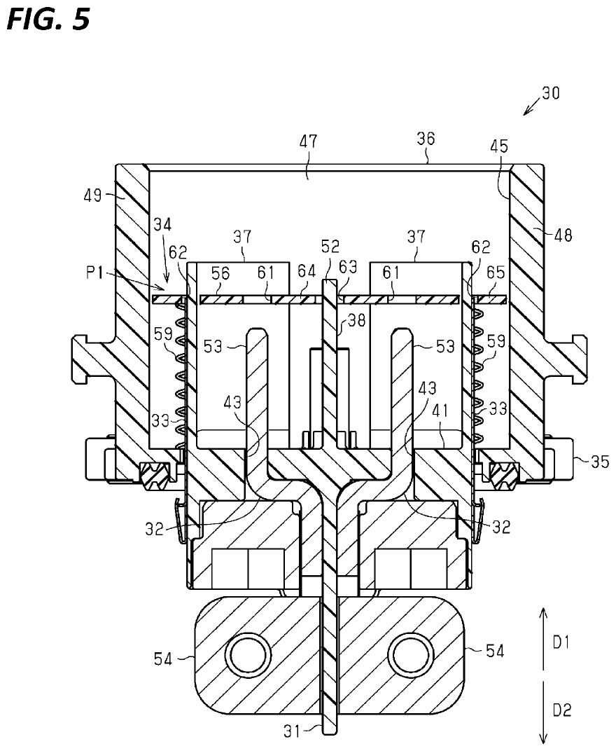

As shown in FIGS. 5 and 6, the pressing member 59 is located between the protecting member 56 and the fixing portion 35. Specifically, the pressing member 59 is provided between the protecting member 56 and the facing surface 41. The pressing member 59 is mounted on the protecting member 56 and the facing surface 41. The pressing member 59 is mounted on the pressing part 65 of the protecting member 56.

One or more pressing members 59 are provided. In this embodiment, four pressing members 59 are provided. The four pressing members 59 are respectively provided at four corner positions of the protecting member 56 when the second housing 31 is viewed from the second direction D2.

The pressing member 59 is a member for pressing the protecting member 56 in the first direction D1. The pressing member 59 is, for example, resilient. The pressing member 59 presses the protecting member 56 in the second direction D2 by a resilient force thereof. Although the pressing member 59 of this embodiment is a coil spring, the pressing member 59 may be another spring or rubber.

(Movements of Protecting Member 56)

Next, movements of the protecting member 56 are described.

The pressing members 59 press the protecting member 56 in the first direction D1, whereby the protecting member 56 moves in the first direction D1. The protecting member 56 is located at a first position P1 by moving in the first direction D1. The protecting member 56 shown in FIGS. 5 and 6 is located at the first position P1.

When the protecting member 56 is located at the first position P1, the first hook part 52 and the protecting part 64 are in contact. That is, the first hook part 52 contacts the protecting member 56 when the protecting member 56 is located at the first position P1. At this time, the first hook part 52 is caught by the protecting member 56. In particular, the first hook part 52 is caught on an edge of the third through hole 63.

When the protecting member 56 is located at the first position P1, the second hook part 74 and the fixing portion 35 are in contact. That is, the second hook part 74 contacts the second housing 31 when the protecting member 56 is located at the first position P1. At this time, the second hook part 74 is caught by the second housing 31. In particular, the second hook part 74 is caught on an edge of the second insertion hole 44.

When the protecting member 56 is located at the first position P1, the first and second hook parts 52, 74 are respectively in contact with the protecting member 56 and the second housing 31, whereby the pressing members 59 receive a force for pressing the protecting member 56 in the first direction D1. As a result, the protecting member 56 is held in the second housing 31. As just described, the holding portion 38 and the holding member 58 of this embodiment function as a stopper for suppressing the detachment of the protecting member 56 from the second housing 31.

When the protecting member 56 is located at the first position P1, the second terminals 32 are not passed through the first through holes 61. When the protecting member 56 is located at the first position P1, the protecting portions 37 are passed through the second through holes 62. That is, when the protecting member 56 is located at the first position P1, the second terminals 32 are not passed through the first through holes 61, whereas the protecting portions 37 are passed through the second through holes 62. When the protecting member 56 is located at the first position P1, the shield members 33 are not passed through the second through holes 62 although being inserted in the second through holes 62. When the protecting member 56 is located at the first position P1, the holding portion 38 is passed through the third through hole 63. Thus, the protecting member 56 located at the first position P1 is located at a position between the tips of the protecting portions 37 and the tips of the second terminals 32 in the first direction D1. In short, the first position P1 is a position between the tips of the protecting portions 37 and the tips of the second terminals 32 in the first direction D1.

Since the second terminals 32 are not passed through the second through holes 62 when the protecting member 56 is located at the first position P1, the second terminals 32 are not exposed from the protecting member 56. That is, when the protecting member 56 is located at the first position P1, the second terminals 32 are covered by the protecting member 56. In this way, the second terminals 32 are protected by the protecting member 56. In this embodiment, the second terminals 32 are protected by the protecting member 56 and the protecting portions 37. In this way, it is suppressed that the worker's fingers touch the second terminals 32.

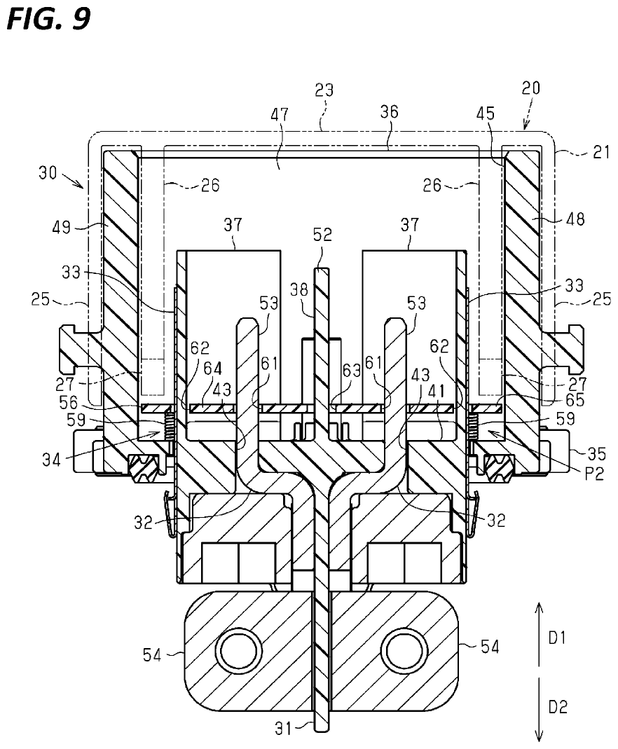

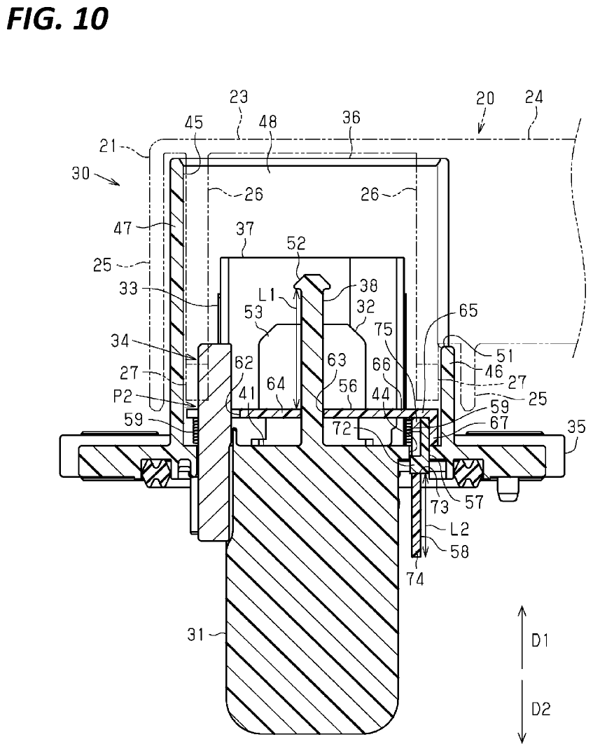

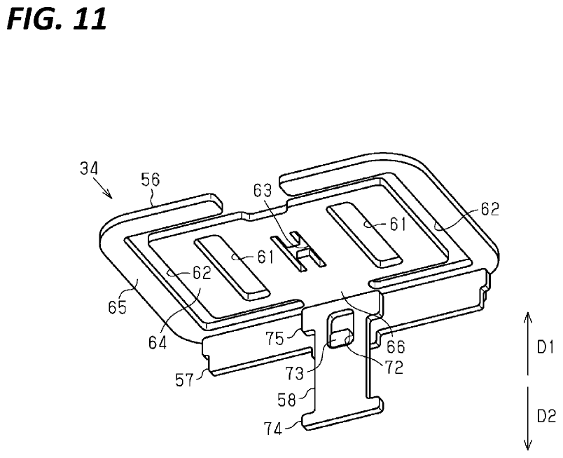

As shown in FIGS. 9 and 10, when the first and second connectors 20, 30 are assembled, the first connector 20 presses the protecting member 56 in the second direction D2, whereby the protecting member 56 moves from the first position P1 to a second position P2. At this time, the sealing member 27 presses the pressing part 65 in the second direction D2. The sealing member 27 contacts the pressing part 65 and also contacts the peripheral wall 36. By the contact of the sealing member 27 and the peripheral wall 36, the first and second connectors 20, 30 are sealed. The protecting member 56 moves to the second position P2 by moving in the second direction D2 from the first position P1. The protecting member 56 shown in FIGS. 9 and 10 is located at the second position P2.

As shown in FIGS. 9, 10 and 11, if the protecting member 56 located at the first position P1 is pressed in the second direction D2 by the first connector 20, the protecting member 56 moves in the second direction D2 together with the connecting member 57 and the holding member 58. At this time, the first hook part 52 and the protecting member 56 are separated. Further, the second hook part 74 and the fixing portion 35 are separated.

If the protecting member 56 is further pressed in the second direction D2 by the first connector 20, the third hook part 75 contacts the fixing portion 35. At this time, the third hook part 75 is caught on an edge of the second insertion hole 44. The holding member 58 stops by the contact of the third hook part 75 with the fixing portion 35. Thus, the protecting member 56 and the connecting member 57 move in the second direction D2 with respect to the holding member 58.

If the protecting member 56 is further pressed in the second direction D2 by the first connector 20, the connecting member 57 contacts the fixing portion 35. At this time, the connecting member 57 contacts the facing surface 41. The connecting member 57 stops by contacting the fixing portion 35. Thus, the protecting member 56 moves in the second direction D2 with respect to the connecting member 57 and the holding member 58.

If the protecting member 56 is further pressed in the second direction D2 by the first connector 20, the mounting part 67 contacts the fixing portion 35. At this time, the mounting part 67 contacts the facing surface 41. The protecting member 56 stops by the contact of the mounting part 67 with the fixing portion 35. In this way, the protecting member 56 moves to the second position P2. Thus, a position where the mounting part 67 is in contact with the facing surface 41 can be said to be the second position P2. In this way, the facing surface 41 receives a force of the first connector 20 pressing the protecting member 56.

Here, it is assumed that a displacement amount when the protecting member 56 is displaced from the first position P1 to the second position P2 is a first displacement amount L1 and a displacement amount of the holding member 58 being displaced according to a displacement of the protecting member 56 is a second displacement amount L2. Since the holding member 58 is connected to the protecting member 56 in a state movable in the first and second directions D1, D2 with respect to the protecting member 56, the second displacement amount L2 is smaller than the first displacement amount L1. Since the connecting member 57 movable in the first and second directions D1, D2 with respect to the protecting member 56 and the holding member 58 is interposed between the protecting member 56 and the holding member 58 in this embodiment, the second displacement amount L2 is even smaller than the first displacement amount L1. In this way, a protrusion amount of the holding member 58 protruding in the second direction D2 from the second insertion hole 44 is reduced when the protecting member 56 is located at the second position P2.

In the process of displacing the protecting member 56 from the first position P1 to the second position P2, the second terminals 32 are inserted into the first through holes 61. Thus, when the protecting member 56 is located at the second position P2, the second terminals 32 are passed through the first through holes 61. When the protecting member 56 is located at the second position P2, the protecting portions 37 are passed through the second through holes 62. When the protecting member 56 is located at the second position P2, the shield members 33 are passed through the second through holes 62. When the protecting member 56 is located at the second position P2, the holding portion 38 is passed through the third through hole 63. Thus, the protecting member 56 located at the second position P2 is located at a position between the tips of the second terminals 32 and the facing surface 41 in the first direction D1. In short, the second position P2 is the position between the tips of the second terminals 32 and the facing surface 41 in the first direction D1.

When the protecting member 56 is located at the second position P2, the second terminals 32 are passed through the first through holes 61, thereby being exposed from the protecting member 56. In this way, the second terminals 32 can contact the first terminals 22. Specifically, when the first and second connectors 20, 30 are assembled, the second terminals 32 are inserted into the region surrounded by the inner peripheral wall 26. As a result, the second terminals 32 contact the first terminals 22. If the first and second connectors 20, 30 are disassembled, the protecting member 56 is displaced from the second position P2 to the first position P1 by being pressed by the pressing members 59.

As described above, the protecting member 56 is displaced between the first position P1 and the second position P2 by moving in the first and second directions D1, D2. That is, the protecting member 56 is displaced to the first position P1 by being pressed by the pressing members 59 unless the first and second connectors 20, 30 are assembled. The protecting member 56 is displaced to the second position P2 by being pressed by the first connector 20 when the first and second connectors 20, 30 are assembled. To summarize, as the first and second connectors 20, 30 are assembled, the protecting member 56 is displaced to the second position P2. As the first and second connectors 20, 30 are disassembled, the protecting member 56 is displaced to the first position P1.

The protecting member 56 moves in the first and second directions D1, D2 along the protecting portions 37 when being displaced between the first position P1 and the second position P2. That is, the protecting member 56 moves while being guided by the protecting portions 37. Thus, the protecting portions 37 guide a movement of the protecting member 56. In this embodiment, the holding portion 38 also guides the movement of the protecting member 56.

Next, functions and effects of this embodiment are described.

(1) The protecting member 56 includes the first through holes 61 for insertion of the second terminals 32 and the second through holes 62 for insertion of the protecting portions 37. The protecting member 56 is displaced between the first position P1 between the tips of the protecting portions 37 and the tips of the second terminals 32 in the first direction D1 and the second position P2 between the tips of the second terminals 32 and the facing surface 41 in the first direction D1.

According to the above configuration, the second terminals 32 are not passed through the first through holes 61 when the protecting member 56 is located at the first position P1. In this case, the second terminals 32 are protected by the protecting member 56 without being exposed from the protecting member 56. When the protecting member 56 is located at the second position P2, the second terminals 32 are passed through the first through holes 61. In this case, the second terminals 32 are exposed form the protecting member 56.

Both when the protecting member 56 is located at the first position P1 and when the protecting member 56 is located at the second position P2, the protecting portions 37 are passed through the second through holes 62. Thus, the protecting member 56 moves while being guided by the protecting portions 37 when the protecting member 56 is displaced between the first position P1 and the second position P2. That is, the protecting portions 37 guide the protecting member 56. In this way, it is suppressed that the protecting member 56 rubs against the second terminals 32. As a result, the wear of the second terminals 32 is suppressed.

(2) The protecting portions 37 are provided to surround the second terminals 32 when the second housing 31 is viewed from the second direction D2.

According to the above configuration, the protecting member 56 is unlikely to be inclined when moving in the first and second directions D1, D2 as compared to the case where the protecting portions 37 have, for example, a mere flat shape. In this way, the wear of the second terminals 32 can be suppressed. For example, if the protecting member 56 moves in the first and second directions D1, D2 in an inclined state, the protecting member 56 easily rubs against the second terminals 32.

(3) The shield members 33 made of metal are provided along the protecting portions 37.

According to the above configuration, the shield members 33 are provided to surround the second terminals 32. Thus, a possibility of noise entrance from the second terminals 32 is reduced.

(4) The first through holes 61 and the second through holes 62 are respectively independent holes.

According to the above configuration, an area of the holes open in the protecting member 56 is reduced as compared to the case where the first and second through holes 61, 62 are constituted by one common hole. Since the second terminals 32 become less likely to be exposed from the protecting member 56 in this way, a possibility that the worker's fingers touch the second terminals 32 is reduced.

(5) The pressing members 59 provided between the facing surface 41 and the protecting member 56 press the protecting member 56 in the first direction D1. The protecting member 56 is pressed in the second direction D2 by the first connector 20 when the first and second connectors 20, 30 are assembled.

According to the above configuration, as the first and second connectors 20, 30 are assembled, the protecting member 56 is displaced to the second position P2. As the first and second connectors 20, 30 are disassembled, the protecting member 56 is displaced to the first position P1. Thus, a possibility that the protecting member 56 is inadvertently displaced to the second position P2 is reduced. That is, since the second terminals 32 become less likely to be exposed from the protecting member 56, a possibility that the worker's fingers touch the second terminals 32 is reduced.

(6) The first hook part 52 is in contact with the protecting member 56 when the protecting member 56 is located at the first position P1.

According to the above configuration, a movement in the first direction D1 of the protecting member 56 located at the first position P1 is suppressed by the contact of the first hook part 52 with the protecting member 56. In this way, a possibility of detachment of the protecting member 56 from the second housing 31 is reduced.

(7) The second hook part 74 is in contact with the second housing 31 when the protecting member 56 is located at the first position P1.

According to the above configuration, a movement in the first direction D1 of the protecting member 56 located at the first position P1 is suppressed by the contact of the second hook part 74 with the first housing 31. In this way, a possibility of detachment of the protecting member 56 from the second housing 31 is reduced.

(8) The second connector 30 includes the connecting member 57 to be connected to the protecting member 56 and the holding member 58 in a state movable in the first and second directions D1, D2 with respect to the protecting member 56 and the holding member 58.

According to the above configuration, the second displacement amount L2 of the holding member 58 is smaller than the first displacement amount L1 of the protecting member 56 when the protecting member 56 is displaced from the first position P1 to the second position P2. By the smaller second displacement amount L2, a protrusion amount of the holding member 58 protruding out from the second housing 31 in the second direction D2 from the second insertion hole 44 becomes smaller when the protecting member 56 is located at the second position P2. In this way, a possibility of interference of the holding member 58 with another member is reduced.

(9) Since the protecting portions 37 for protecting the second terminals 32 guide the protecting member 56, the configuration of the second connector 30 can be simplified as compared to the case where a mechanism for protecting the second terminals and a mechanism for guiding the protecting member 56 are separately provided.

(Modifications)

The above embodiment can be modified and carried out as follows. The above embodiment and the following modifications can be carried out in combination without technically contradicting each other.
The protecting mechanism 34 may include the protecting member 56 and the holding member 58 without including the connecting member 57. In this case, the holding member 58 is connected to the protecting member 56 in a state movable in the first and second directions D1, D2 with respect to the protecting member 56. Also in this modification, the second displacement amount L2 can be made smaller than the first displacement amount L1.
The protecting mechanism 34 may include only the protecting member 56 without including the connecting member 57 and the holding member 58. Also in this case, the protecting member 56 can be held by the holding portion 38.
The holding portion 38 may not include the first hook part 52. Also in this case, the protecting member 56 can be held by the second hook part 74.
The protecting member 56 may include the second hook part 74. In this case, the protecting mechanism 34 includes, for example, only the protecting member 56 without including the connecting member 57 and the holding member 58. Also in this modification, the protecting member 56 can be held by the second hook part 74.
The first and second through holes 61, 62 may be constituted by one common hole. Furthermore, the first, second and third through holes 61, 62 and 63 may be constituted by one common hole.
The protecting member 56 may be displaced between the first position P1 and the second position P2, for example, by the operation of a worker without depending on the assembling of the first and second connectors 20, 30.
The protecting portions 37 may have a uniform cross-sectional shape over a length range of the protecting portions 37 at least corresponding to a stroke length of the protecting member 56. For example, the protecting portions 37 shown in FIGS. 3, 5 and 6 extend in parallel to the first direction D1 and have a uniform cross-sectional shape over the entire protecting portions 37 in the first direction D1. The protecting portions 37 may be referred to as guide walls or linear rails. The protecting portions 37 and the protecting members 56 of the above embodiment may be respectively referred to as immovable guards and a movable guard. The tips of the protecting portions 37 may be referred to as guard upper ends.
As shown in FIG. 3, the protecting portion 37 serving as a guide wall may have a flat plate-like wall (also referred to as a first guide wall) arranged in parallel to the first part 53 of the second terminal 32. Further, the guide wall may have a wall (also referred to as a second guide wall) connected to one end of the first guide wall when the guide wall is viewed from the second direction. The second guide wall may be in the form of a flat plate orthogonal to the first guide wall. Furthermore, the guide wall may have a wall (also referred to as a third guide wall) connected to the other end of the first guide wall when the guide wall is viewed from the second direction. The third guide wall may be in the form of a flat plate orthogonal to the first guide wall and parallel to the second guide wall.
As shown in FIG. 3, the third and fourth walls 48, 49 of the peripheral wall 36 may be in the form of flat plates parallel to the first guide wall. The first and second walls 46, 47 of the peripheral wall 36 may be in the form of flat plates parallel to the second and third guide walls.
As shown in FIG. 3, the second through hole 62 may be a groove-like hole conforming to the contour of the guide wall when viewed from the second direction. In particular, the second through hole 62 may include a groove-like hole part (also referred to as a first groove portion) into which the first guide wall is inserted. The first groove portion may extend straight in parallel to the first guide wall. Further, the second through hole 62 may include a groove-like hole part (also referred to as a second groove portion) which is connected to one end of the first groove portion and into which the second guide wall is inserted. The second groove portion may extend straight perpendicularly to the first groove portion. Furthermore, the second through hole 62 may include a groove-like hole part (also referred to as a third groove portion) which is connected to the other end of the first groove portion and into which the third guide wall is inserted. The third groove portion may extend straight perpendicularly to the first groove portion.
As shown in FIGS. 3 and 4, the shield member 33 may be provided along the outer surface of the guide wall. As shown in FIG. 5, a length from the tip of the shield member 33 to the facing surface 41 may be substantially equal to a distance from the protecting member 56 at the first position P1 to the facing surface 41.
A width of the second through hole 62 may be substantially equal to or slightly larger than the sum of a thickness of the guide wall and a thickness of the shield member 33. In particular, a width of the first groove portion may be substantially equal to or slightly larger than the sum of a thickness of the first guide wall and the thickness of the shield member 33. A width of the second groove portion may be substantially equal to or slightly larger than the sum of a thickness of the second guide wall and the thickness of the shield member 33. A width of the third groove portion may be substantially equal to or slightly larger than the sum of a thickness of the third guide wall and the thickness of the shield member 33.
As shown in FIGS. 3 and 6, the third through hole 63 may be provided in the center of the protecting member 56. The first hook part 52 of the holding portion 38 may be caught in a central part of the protecting member 56 by being caught on the edge of the third through hole 63.
For example, by providing the four positioning members 59 respectively at four corner positions of the protecting member 56 as shown in FIGS. 5 and 6, a plurality of the positioning members 59 may be rotationally symmetrically provided with respect to the center of the protecting member 56 so that the protecting member 56 is not inclined.
The facing surface 41 may be referred to as a base surface of the second housing 31. The peripheral wall 36 of the embodiment may be referred to as a receptacle of the second housing 31. The first direction D1 of this embodiment may be referred to as a height direction of the peripheral wall 36. The exposure opening 51 of the peripheral wall 36 of the embodiment may be referred to as a cutout-like lateral window of the peripheral wall 36.

As shown by cross-section hatching in FIGS. 5, 6, 9 and 10, the second housing 31 may be made of resin, possibly insulating resin, and the second terminals 32 may be metal. The second housing 31 may be configured as a one-piece article as in a shown example.

As shown in FIG. 1, the protecting member 56 can stay at the first position P1 with the first and second connectors 20, 30 separated. When the protecting member 56 is at the first position P1, a lateral end surface of the protecting member 56 may be partially exposed from the exposure opening 51 of the peripheral wall 36 and, for example, may cross the exposure opening 51 of the peripheral wall 36. Accordingly, the single protecting member 56 at the first position P1 is advantageous in suppressing the touch of worker's fingers approaching the second connector 30 from above the peripheral wall 36 with the second terminals 32 and is also advantageous in suppressing the touch of worker's fingers approaching the second connector 30 from a lateral side of the peripheral wall 36 with the second terminals 32 through the exposure opening 51 of the peripheral wall 36 when the worker connects the second and first connectors 30, 20.

The present disclosure includes the following implementation examples. Reference signs of several constituent elements of the illustrative embodiment are given not for limitation, but for understanding assistance. Some of features described in the following implementation examples may be omitted or several of the features described in the implementation examples may be selected or extracted and combined.

[Addendum 1] A connector (30) including:

a housing (31) having a base surface (41);

a terminal (32) held in the housing (31) and projecting in a first direction (D1) from the base surface (41); and

a protecting member (56) held in the housing (31) and configured to move in the first direction (D1) and a second direction (D2) opposite to the first direction (D1) in the housing (31),

wherein:

the housing (31) includes a guide wall (37) for protecting the terminal (32),

the guide wall (37) projects in the first direction (D1) from the base surface (41),

a projection amount of the guide wall (37) is larger than that of the terminal (32),

the protecting member (56) includes a first through hole (61) for insertion of the terminal (32) and a second through hole (62) for insertion of the guide wall (37), and

the protecting member (56) is displaced between a first position (P1) between a tip of the guide wall (37) and a tip of the terminal (32) in the first direction (D1) and a second position (P2) between the tip of the terminal (32) and the base surface (41) in the first direction (D1).

[Addendum 2] In one aspect of the present disclosure, the guide wall (37) may extend in parallel to the first direction (D1) and have a uniform cross-sectional shape over an entire region in the first direction (D1).

[Addendum 3] The connector (30) according to one aspect of the present disclosure may include a shield member (33) made of metal,

the shield member (33) may be provided along an outer surface of the guide wall (37),

the second through hole (62) may be a groove-like hole conforming to the contour of the guide wall (37) when viewed from the second direction (D2), and

a width of the second through hole (62) may be substantially equal to or slightly larger than the sum of a thickness of the guide wall and a thickness of the shield member (33).

[Addendum 4] In one aspect of the present disclosure,

the terminal (32) may project from the base surface (41) and include a flat plate-like first part (53),

the guide wall (37) may include:
a flat plate-like first guide wall arranged in parallel to the first part (53);
a second guide wall connected to one end of the first guide wall when viewed from the second direction (D2); and
a third guide wall connected to the other end of the first guide wall when viewed from the second direction (D2), and

the second and third guide walls may be respectively in the form of flat plates orthogonal to the first guide wall.

[Addendum 5] In one aspect of the present disclosure,

the second through hole (62) may include:

a straight first groove portion into which the first guide wall is inserted,

a straight second groove portion which is connected to one end of the first groove portion when viewed from the second direction (D2) and into which the second guide wall is inserted; and

a straight third groove portion which is connected to the other end of the first groove portion when viewed from the second direction (D2) and into which the third guide wall is inserted, and

the second and third groove portions are respectively orthogonal to the first groove portion.

[Addendum 6] The connector (30) according to one aspect of the present disclosure may include a shield member (33) made of metal,

the shield member (33) may be provided along an outer surface of the guide wall (37),

a width of the first groove portion may be substantially equal to or slightly larger than the sum of a thickness of the first guide wall and a thickness of the shield member (33),

a width of the second groove portion may be substantially equal to or slightly larger than the sum of a thickness of the second guide wall and the thickness of the shield member (33), and

a width of the third groove portion may be substantially equal to or slightly larger than the sum of a thickness of the third guide wall and the thickness of the shield member (33).

[Addendum 7] In one aspect of the present disclosure,

the housing (31) may include a peripheral wall provided to surround the terminal (32) and the protecting member (56) when viewed from the second direction (D2), and

the peripheral wall may include:
a first wall and a second wall in the form of flat plates parallel to the second and third guide walls; and
a third wall and a fourth wall in the form of flat plates parallel to the first guide wall.

[Addendum 8] In one aspect of the present disclosure, a length from a tip of the shield member (33) to the base surface (41) may be equal to a distance from the protecting member (56) at the first position (P1) to the base surface (41).

[Addendum 9] In one aspect of the present disclosure,

the housing (31) may include a holding portion (38) projecting in the first direction (D1) from the base surface (41),

a projection amount of the holding portion (38) may be larger than that of the terminal (32) and smaller than that of the guide wall (37),

the holding portion (38) may include a first hook part (52) on a tip thereof,

the protecting member (56) may include a third through hole (63) for insertion of the holding portion (38),

the third through hole (63) may be provided in a center of the protecting member (56), and

the first hook part (52) may be caught in a central part of the protecting member (56) by being caught on an edge of the third through hole (63).

[Addendum 10] The connector (30) according to one aspect of the present disclosure may include a plurality of pressing members (58) provided between the base surface (41) and the protecting member (56),

each of the plurality of pressing members (58) may press the protecting member (56) in the first direction (D1), and

the plurality of pressing members (58) may be rotationally symmetrically provided with respect to a center of the protecting member (56) so that the protecting member (56) is not inclined.

[Addendum 11] A connector (30) according to one aspect of the present disclosure may include:

a resin housing (31) having a base surface (41) and a receptacle (36) rising in a height direction (D1) from the base surface (41);

a terminal group including a plurality of metal terminals (32) arranged inside the receptacle (36), each metal terminal (32) of the terminal group extending in the height direction (D1) and having a straight part with a free end; and

an immovable guard (37) and a movable guard (56) arranged inside the receptacle (36) and configured to guide the terminal group,

wherein:

the immovable guard (37) may be arranged inside the receptacle (36) and outside the terminal group when the connector (30) is viewed from the height direction (D1) and have a guard upper end below an uppermost end of the receptacle (36) and above the free ends of the plurality of metal terminals (32) of the terminal group,

the immovable guard (37) may be configured as a linear rail (37) for guiding the movable guard (56) so that the movable guard (56) linearly reciprocally moves between a first height position (P1) above the free ends of the plurality of metal terminals (32) of the terminal group in the height direction (D1) and a second height position (P2) below the free ends of the plurality of metal terminals (32) of the terminal group in the height direction (D1), and

the movable guard (56) may include a first through hole (61) for allowing passage of the straight parts of the metal terminals (32) and a second through hole (62) for allowing passage of the immovable guard (37).

[Addendum 12] In one aspect of the present disclosure,

the immovable guard (37) may be constituted by a plurality of angular linear rails each having one or more corner portions, and

the second through hole (62) of the movable guard (56) may include a plurality of corner portions respectively corresponding to the corner portions of the plurality of angular linear rails.

[Addendum 13] In one aspect of the present disclosure,

the receptacle (36) may include a cutout-like lateral window (51) on a lateral side in a direction different from the height direction (D1), and

a lateral end surface of the movable guard (56) may cross the cutout-like lateral window (51) of the receptacle (36) when the movable guard (56) is at the first height position (P1).

### LIST OF REFERENCE NUMERALS

10 electrical connection device
20 first connector
21 first housing
22 first terminal
23 first accommodating portion
24 second accommodating portion
25 outer peripheral wall
26 inner peripheral wall
27 sealing member
28 accommodation opening
29 wire
30 second connector
31 second housing
32 second terminal
33 shield member
34 protecting mechanism
35 fixing portion
36 peripheral wall
37 protecting portion
38 holding portion
41 facing surface
42 fixing hole
43 first insertion hole
44 second insertion hole
45 connection opening
46 first wall
47 second wall
48 third wall
49 fourth wall
51 exposure opening
52 first hook part
53 first part
54 second part
56 protecting member
57 connecting member
58 holding member
59 pressing member
61 first through hole
62 second through hole
63 third through hole
64 protecting part
65 pressing part
66 coupling part
67 mounting part
68 first pin
71 first hole
72 second pin
73 second hole
74 second hook part
75 third hook part
D1 first direction
D2 second direction
L1 first displacement amount
L2 second displacement amount
P1 first position
P2 second position

1. A connector, comprising:
a housing having a facing surface facing a mating connector when the connector is assembled with the mating connector;
a terminal held in the housing, the terminal projecting in a first direction from the facing surface; and
a protecting member held in the housing, the protecting member moving in the first direction and a second direction opposite to the first direction in the housing,
wherein:
the housing includes a protecting portion for protecting the terminal,
the protecting portion projects in the first direction from the facing surface,
a projection amount of the protecting portion is larger than that of the terminal,
the protecting member includes a first through hole for insertion of the terminal and a second through hole for insertion of the protecting portion, and
the protecting member is displaced between a first position between a tip of the protecting portion and a tip of the terminal in the first direction and a second position between the tip of the terminal and the facing surface in the first direction.

2. The connector of claim 1, wherein the protecting portion is provided to surround the terminal when the housing is viewed from the second direction.

3. The connector of claim 2, comprising a shield member made of metal, wherein the shield member is provided along the protecting portion.

4. The connector of claim 1, wherein the first and second through holes are respectively independent holes.

5. The connector of claim 1, comprising a pressing member provided between the facing surface and the protecting member, wherein:
the pressing member presses the protecting member in the first direction, and
the protecting member is pressed in the second direction by the mating connector when the connector and the mating connector are assembled.

6. The connector of claim 1, wherein:
the housing includes a holding portion projecting in the first direction from the facing surface,
a projection amount of the holding portion is larger than that of the terminal and smaller than that of the protecting portion,
the holding portion includes a first hook part on a tip thereof,
the protecting member includes a third through hole for insertion of the holding portion, and
the first hook part contacts the protecting member when the protecting member is located at the first position.

7. The connector of claim 1, comprising a holding member to be connected to the protecting member, wherein:
the holding member includes a second hook part on an end part thereof,
the housing includes an insertion hole for insertion of the holding member, and
the second hook part contacts the housing when the protecting member is located at the first position.

8. The connector of claim 7, comprising a connecting member to be connected to the protecting member and the holding member in a state movable in the first and second directions with respect to the protecting member and the holding member, wherein:
the holding member is connected to the protecting member via the connecting member.
